(19) United States
(12) Patent Application Publication
(10) Pub. No.: US 2018/0097991 A1
(43) Pub. Date: Apr. 5, 2018

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Futoshi Hachimura, Kawasaki-shi (JP)

(21) Appl. No.: 15/716,354

(22) Filed: Sep. 26, 2017

(30) Foreign Application Priority Data
Sep. 30, 2016 (JP) 2016-193702

(51) Int. Cl. H04N 5/232; H04N 7/18; G06T 7/292; G06T 11/00; H04N 5/14

(52) U.S. Cl. CPC H04N 5/23222; H04N 7/181; H04N 5/23216; G06T 7/292; G06T 2207/30241; H04N 5/145; H04N 5/23206; G06T 2207/10016; G06T 2207/30232; G06T 11/00

(57) ABSTRACT

Input of path information is received, and tracking processing is performed on a subject contained in a video image captured by an image capturing device selected based on the path information.

### BACKGROUND

### Field

The present disclosure relates to an information processing apparatus, an information processing method, and a storage medium.

### Description of the Related Art

Japanese Patent Application Laid-Open No. 2015-19248 discusses a tracking support apparatus for supporting monitoring a person in operation of tracking a tracking target subject. The tracking support apparatus includes a tracking target setting unit for setting a designated subject as a tracking target according to an input operation performed by the monitoring person to designate the tracking target subject on a display portion in a monitoring screen.

### SUMMARY

According to an aspect of the present disclosure, an information processing apparatus includes a reception unit configured to receive input of information about a path, a selection unit configured to select an image capturing device corresponding to the path from a plurality of image capturing devices based on the received information about the path, and a processing unit configured to track a subject contained in an image captured by the selected image capturing device.

Further features will become apparent from the following description of exemplary embodiments with reference to the attached drawings.

### BRIEF DESCRIPTION OF THE DRAWINGS

FIG. 1 illustrates an example of a hardware configuration of a management server.

FIG. 2 illustrates an example of a software configuration of the management server.

FIG. 3 is a flow chart illustrating an example of main information processing.

FIG. 4 illustrates an example of a region map about a monitoring target region.

FIG. 5 illustrates an example of a camera map with camera location information superimposed on the region map.

FIG. 6 illustrates an example of a state in which movement path determination is completed.

FIG. 7 illustrates an example of a case in which a deflection range α is a significant range.

FIG. 8 illustrates an example of a state in which a plurality of cameras is selected.

FIG. 9 illustrates an example of a software configuration of a management server.

FIG. 10 is a flow chart illustrating an example of information processing.

FIG. 11 is a flow chart illustrating an example of a process of drawing a movement path.

FIG. 12 illustrates an example of a state in which a drawing of a predicted movement path line is completed.

FIG. 13 is a flow chart illustrating an example of a process of analyzing a predicted movement path.

FIG. 14 illustrates an example of a state in which a plurality of cameras is selected.

FIG. 15 is a flow chart illustrating an example of a process of drawing a freehand line.

### DESCRIPTION OF THE EMBODIMENTS

An exemplary embodiment will be described below with reference to the drawings.

A subject tracking system includes a management server 1 and a plurality of cameras 2.

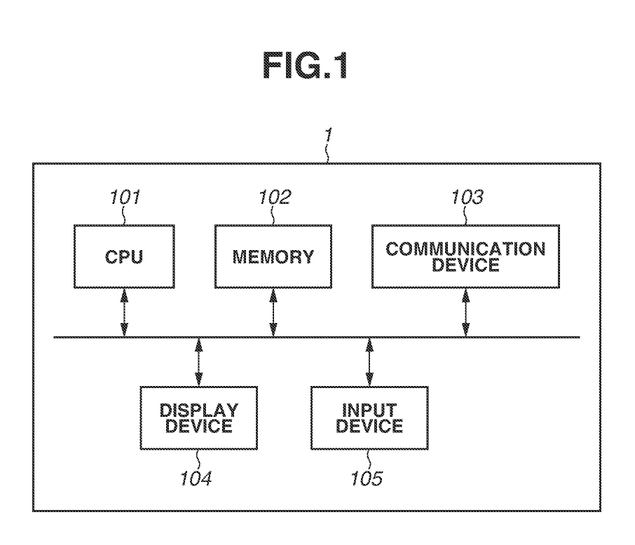

FIG. 1 illustrates an example of a hardware configuration of the management server 1.

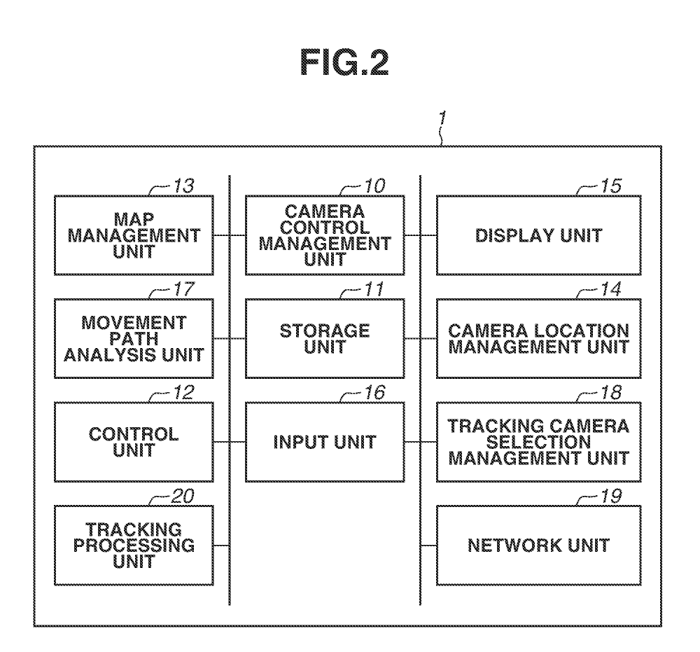

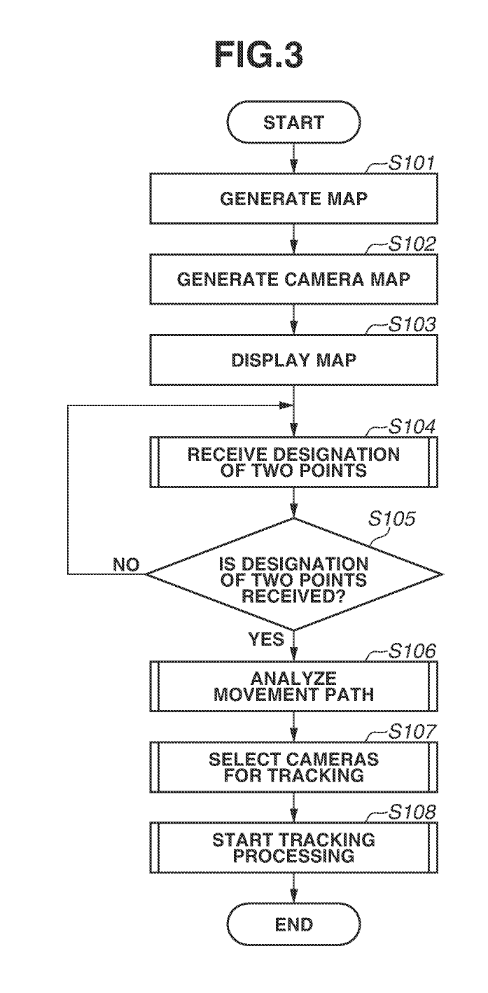

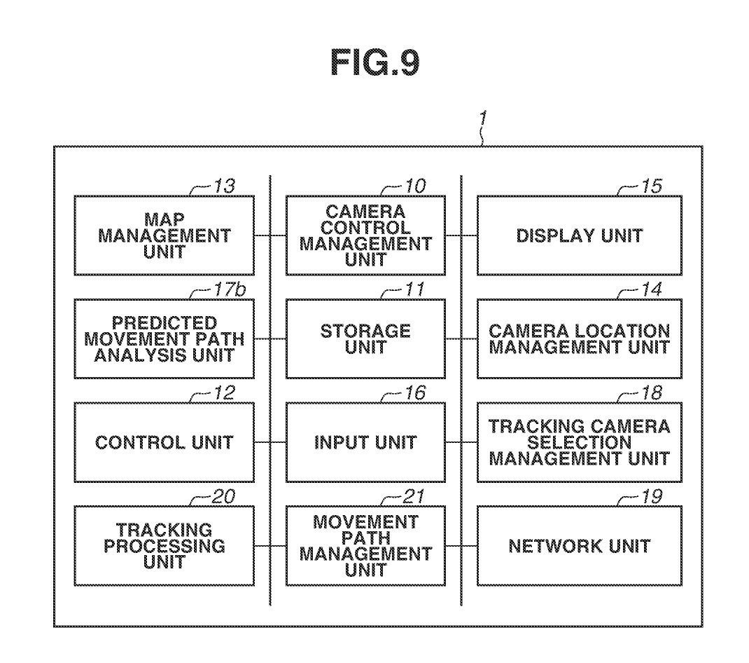

The hardware configuration of the management server 1 includes a central processing unit (CPU) 101, a memory 102, a communication device 103, a display device 104, and an input device 105. The CPU 101 controls the management server 1. The memory 102 stores data, programs, etc. to be used by the CPU 101 in processing. The input device 105 is a mouse, button, etc. for inputting user operations to the management server 1. The display device 104 is a liquid crystal display device, etc. for displaying results of processing performed by the CPU 101, etc. The communication device 103 connects the management server 1 to a network. The CPU 101 executes processing based on programs stored in the memory 102 to realize software configurations of the management server 1 illustrated in FIGS. 2 and 9 and processes illustrated in flow charts in FIGS. 3, 10, 11, 13, and 15 described below.

FIG. 2 illustrates an example of a software configuration of the management server 1.

The software configuration of the management server 1 includes a camera control management unit 10, a storage unit 11, a control unit 12, a map management unit 13, a camera location management unit 14, a display unit 15, an input unit 16, a movement path analysis unit 17, a tracking camera selection management unit 18, a network unit 19, and a tracking processing unit 20. The camera control management unit 10 controls and manages the capturing of image frames by the cameras 2, receipt of image frames from the cameras 2, etc.

The storage unit 11 records, stores, etc., in the memory 102, image frames from the camera control management unit 10 and moving image data generated by successive compression of image frames.

The control unit 12 controls the management server 1.

The map management unit 13 illustrates a region map as an environment in which the cameras 2 are located.

The camera location management unit 14 generates and manages location information specifying the locations of the plurality of cameras 2 on the region map managed by the map management unit 13.

The display unit 15 displays, via the display device 104, the region map managed by the map management unit 13 and camera location information about the locations of the cameras 2 superimposed on the region map.

The input unit 16 inputs, to the control unit 12, a tracking path instruction that is input on the displayed region map based on a user operation performed with the input device 105, such as a mouse.

The movement path analysis unit 17 analyzes a movement path based on the information input by the input unit 16.

The tracking camera selection management unit 18 selects at least one of the camera(s) 2 to be used for tracking based on a result of the analysis performed by the movement path analysis unit 17, and manages the selected camera(s) 2.

The network unit 19 mediates transmission and reception of commands and video images between the management server 1 and the cameras 2, another camera management server, or video management software (VMS) server via the network.

The tracking processing unit 20 receives video images from the camera(s) 2 selected by the tracking camera selection management unit 18 via the network unit 19 and performs tracking processing using the video images.

FIG. 3 is a flow chart illustrating an example of information processing.

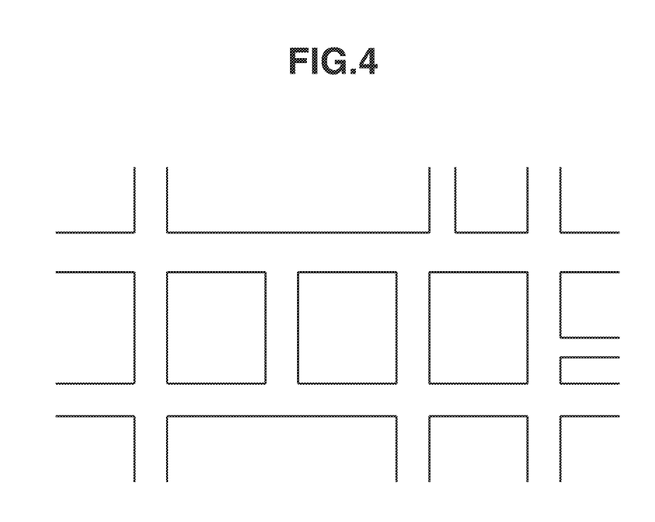

In step S101, the map management unit 13 generates a region map (FIG. 4) regarding a monitoring target region.

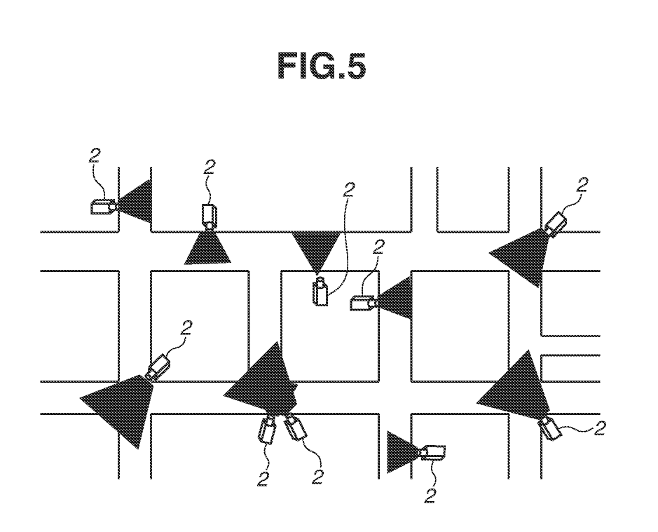

In step S102, the control unit 12 acquires, from the camera location management unit 14, the locations of the plurality of cameras 2 located in the monitoring target region and image-capturing direction information about the directions in which the cameras 2 respectively capture images. The control unit 12 generates a camera map (FIG. 5) with the camera location information superimposed on the region map (FIG. 4) illustrating the monitoring target region, and stores the camera map together with the region map in the memory 102 via the storage unit 11.

The control unit 12 can acquire location information about the cameras 2 as camera location information and image-capturing direction information about the cameras 2 through manual user input of data via the input device 105 for each of the cameras 2. The control unit 12 can acquire, from the camera control management unit 10 via the network unit 19, various types of installation information from the respective target cameras 2, and can generate camera location information and image-capturing direction information in real time concurrently with the analysis of video images captured by the respective target cameras 2.

In step S103, the control unit 12 displays, on the display device 104 via the display unit 15, the region map (FIG. 4) stored in the memory 102.

The control unit 12 can display the camera map (FIG. 5) on the display device 104. However, a user having seen the camera locations can be biased to draw a predicted path based on the camera locations. In order to prevent this situation, the control unit 12 displays the region map (FIG. 4) on the display device 104 in the present exemplary embodiment.

The user designates, with the input device 105, two points as a start point and an end point of a tracking target movement path based on the region map (FIG. 4) displayed on the display device 104. In step S104, the control unit 12 receives designation of two points.

In the present exemplary embodiment, the start point is a point A and the end point is a point B.

In step S105, the control unit 12 determines whether designation of two points is received. If the control unit 12 determines that designation of two points is received (YES in step S105), the processing proceeds to step S106. If the control unit 12 determines that designation of two points is not received (NO in step S105), the processing returns to step S104.

The processing performed in step S104 or in steps S104 and S105 is an example of reception processing of receiving input of information about a movement path of a tracking target subject.

In step S106, after the two points are designated as the start point and the end point of the tracking target movement path, the movement path analysis unit 17 calculates a shortest path between the two points and a plurality of paths based on the shortest path.

The calculation formula is L+L×α.

In the calculation formula, L is the shortest path, and α is a deflection range (allowable range) of the tracking target movement path. The value of α is determined in advance. The value of α can be designated as, for example, time or path length. In general, the time and path length have a proportional relationship. However, in a case where there is a transportation means, such as a moving walkway, escalator, or elevator, on the path, the time and path length do not always have a proportional relationship. For this reason, there are various ways of designating the value of α. For example, the value of α is designated by designating only time, only path length, or both time and path length.

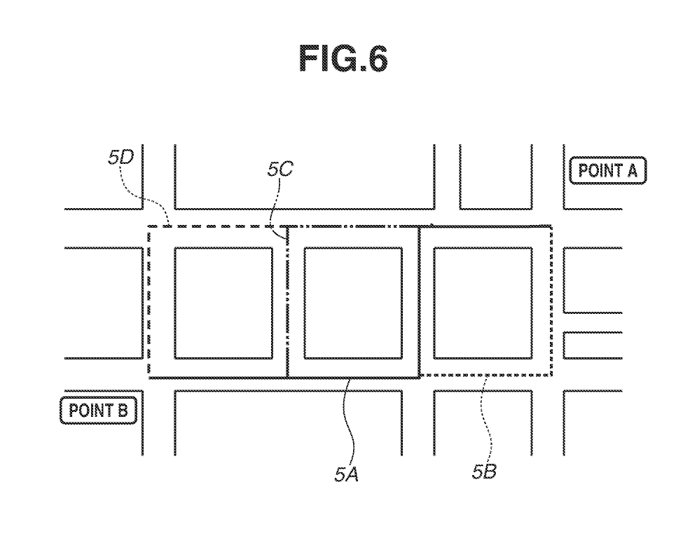

FIG. 6 illustrates a state in which the movement path determination is completed. In FIG. 6, four shortest paths (5A, 5B, 5C, 5D) between the two points, the points A and B, are illustrated. In the present exemplary embodiment, only roads on the ground are considered. While the value of α has no contribution in the example illustrated in FIG. 6, the value of α has significance in a case of a complicated path.

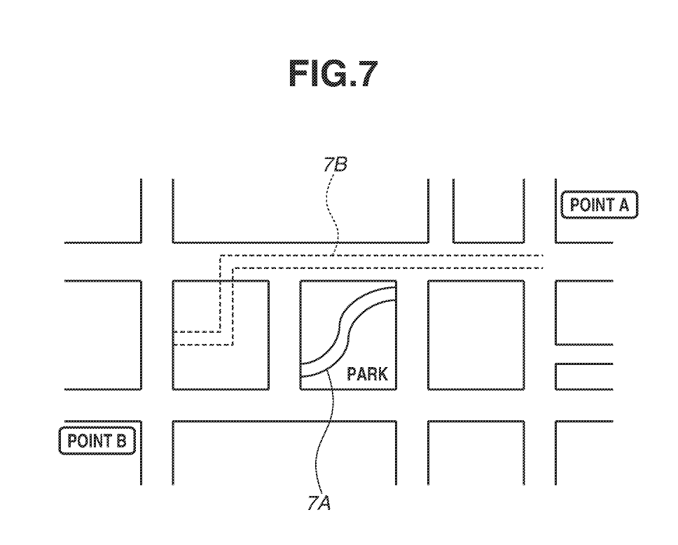

Examples of a possible case in which the value of α is designated as path length include a shortcut (7A) in a park and an underground passage (7B) as in FIG. 7 or a hanging walkway. Examples of a possible case in which the value of α is designated as time include a case where there is a transportation means (moving walkway, escalator, elevator, cable car, gondola, bicycle, motorcycle, bus, train, taxi) or the like on the path.

The control unit 12 executes tracking camera selection processing described below using the tracking camera selection management unit 18 based on results of the movement path determination from the movement path analysis unit 17.

In step S107, the tracking camera selection management unit 18 performs matching calculations on the cameras 2 that capture images of the movement paths as video images based on the camera map (FIG. 5) stored in the storage unit 11 to select a plurality of cameras 2.

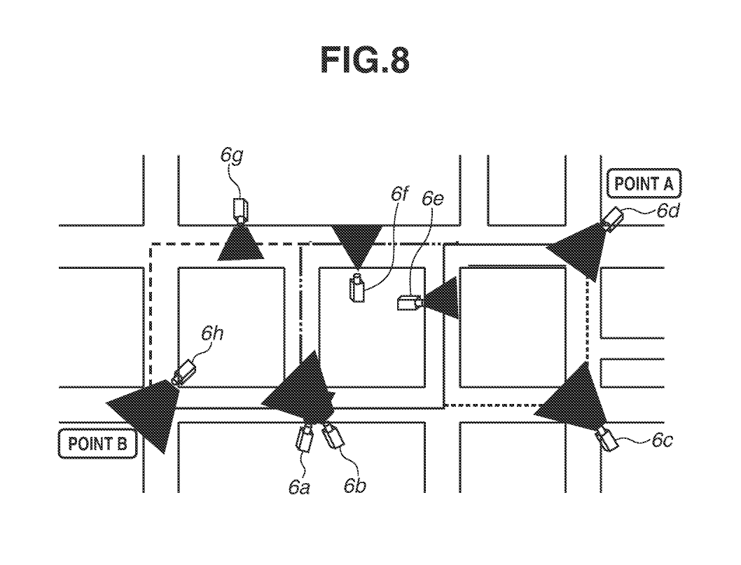

FIG. 8 illustrates a state in which the cameras 2 are selected.

In FIG. 8, cameras 6a to 6h are the selected eight cameras 2.

While there are cases where the viewing fields of the cameras 2 do not overlap, the tracking processing in the present exemplary embodiment uses an algorithm enabling tracking without overlapping viewing fields of cameras.

While the tracking target is expected to be a person in the present exemplary embodiment, the tracking target is not limited to a person and can be any tracking target (subject) if a feature amount from which the tracking target (subject) is identifiable is extractable from video images. The tracking target (subject) can be something other than person, such as a car, a motorcycle, a bicycle, an animal, etc.

The control unit 12 designates the plurality of cameras 2 selected by the tracking camera selection management unit 18, causes the camera control management unit 10 to receive video images from the respective cameras 2 via the network unit 19 from the VMS, and records the received video images in the memory 102 via the storage unit 11.

In step S108, the tracking processing unit 20 analyzes the video images received from the plurality of cameras 2 and recorded in the memory 102 via the storage unit 11, and starts to execute subject tracking processing.

Alternatively, instead of designating the plurality of cameras 2 selected by the tracking camera selection management unit 18, the control unit 12 can select and designate the plurality of video images, acquire the plurality of selected and designated video images from the VMS, and record the acquired video images in the memory 102 via the storage unit 11.

While analyzing a plurality of video images, the tracking processing unit 20 detects subjects (persons) that appear on the movement path, extracts one or more feature amounts of the respective subjects, and compares the feature amounts of the respective subjects. If the level of matching of the feature amounts of the subjects is greater than or equal to a predetermined level, the tracking processing unit 20 determines that the subjects are the same, and starts tracking processing.

The tracking processing unit 20 uses a technique enabling tracking of the same subject (person) even if video images captured by the cameras 2 do not show the same place (even if the viewing fields do not overlap). The tracking processing unit 20 can use a feature amount of a face in the processing of tracking the same subject (person). In order to improve accuracy of the tracking processing, the tracking processing unit 20 can use other information, such as color information, as a feature amount of the subject.

According to the present exemplary embodiment, cameras necessary for tracking are automatically selected and set simply by designating (pointing) two points as a start point and an end point.

FIG. 9 illustrates an example of the software configuration of the management server 1.

The software configuration of the management server 1 in FIG. 9 is similar to the software configuration of the management server 1 in FIG. 2, except that the movement path analysis unit 17 in FIG. 2 is changed to a predicted movement path analysis unit 17b and a movement path management unit 21 is added, so description of similar functions is omitted.

The predicted movement path analysis unit 17b analyzes a predicted movement path based on information input by the user via the input unit 16.

The movement path management unit 21 accumulates and manages, as data, a movement path on which tracking processing is previously performed by the tracking processing unit 20.

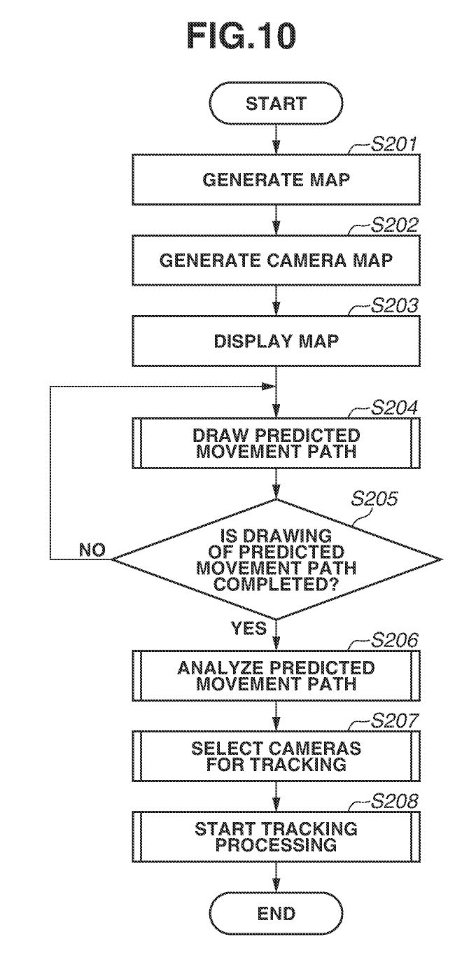

FIG. 10 is a flow chart illustrating an example of information processing corresponding to the configuration illustrated in FIG. 9.

Steps S201 to S203, from the map generation processing to the map display processing, are similar to steps S101 to S103 in FIG. 3, so description of steps S201 to S203 is omitted.

In step S204, the control unit 12 draws, on the display device 104 via the display unit 15, a predicted movement path along which a tracking target is predicted to move, based on information input by the user via the input device 105, etc. based on the region map (FIG. 4) displayed on the display device 104.

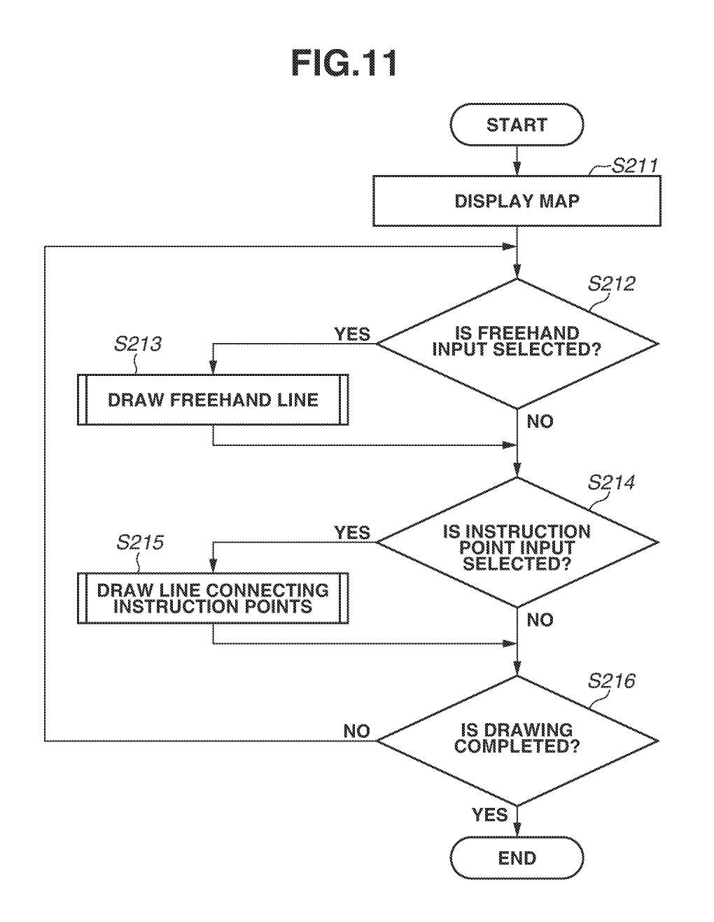

The information processing of drawing a predicted movement path based on user operations will be described in detail below with reference to FIG. 11.

In step S211, the control unit 12 displays the region map illustrated in FIG. 4 on the display device 104 via the display unit 15. The user inputs a predicted movement path line by moving a mouse (computer mouse) pointer, which is an example of the input device 105, on the region map (FIG. 4) on the display device 104.

In the present exemplary embodiment, freehand input and instruction point input, in which instruction points are connected by a line, will be described as methods that are selectable as a method of inputting a predicted movement path line. However, the method of inputting a predicted movement path line is not limited to the freehand input and the instruction point input.

In step S212, the control unit 12 determines whether the freehand input is selected as the method of inputting a predicted movement path line. If the control unit 12 determines that the freehand input is selected (YES in step S212), the processing proceeds to step S213. If the control unit 12 determines that the freehand input is not selected (NO in step S212), the processing proceeds to step S214.

After clicking on the beginning point with a mouse, which is an example of the input device 105, the user drags the mouse to input a predicted movement path line on the region map (FIG. 4) displayed on the display device 104. Alternatively, the user can input a predicted movement path line by clicking on the beginning point, moving the mouse, and then clicking on the end point.

In step S213, the control unit 12 draws a predicted movement path line on the region map (FIG. 4) via the display unit 15 based on the input predicted movement path line. The control unit 12 can limit a movable range of the mouse to a range excluding a range in which the mouse cannot be moved due to the presence of an object, e.g., building, etc. The control unit 12 can, for example, set an entrance of a building as a movement target to enable the mouse pointer to move on the building.

In step S214, the control unit 12 determines whether the instruction point input is selected as the method of inputting a predicted movement path line. If the control unit 12 determines that the instruction point input is selected (YES in step S214), the processing proceeds to step S215. If the control unit 12 determines that the instruction point input is not selected (NO in step S214), the processing proceeds to step S216.

In step S215, after the user clicks on the beginning point with the mouse, which is an example of the input device 105, the control unit 12 draws a line via the display unit 15 to extend the line based on the mouse pointer until a next click. When the user clicks on a next point, the drawn line is determined. Then, the control unit 12 repeats the operation of extending the line based on the mouse pointer until a next click and eventually ends the operation at the double-click of the mouse to draw a predicted movement path line via the display unit 15. The user inputs a line connecting a plurality of points as a predicted movement path. A line that connects points is not limited to a straight line and can be a line that is curved to avoid an object, e.g., building, etc. The predicted movement path analysis unit 17b can execute predicted movement path analysis processing by just designating a plurality of points without connecting the points. The execution of predicted movement path analysis processing is similar to the above-described processing of searching for a shortest path and a path based on the shortest path, so description of the execution of predicted movement path analysis processing is omitted.

After the drawing of the predicted movement path line is completed, the user presses a drawing completion button at the end to end the drawing of the predicted movement path line. In step S216, the control unit 12 determines whether the drawing is completed. If the control unit 12 determines that the drawing is completed (YES in step S216), the process illustrated in the flow chart in FIG. 11 ends. If the control unit 12 determines that the drawing is not completed (NO in step S216), the processing returns to step S212. The control unit 12 determines whether the drawing is completed based on whether the drawing completion button is pressed.

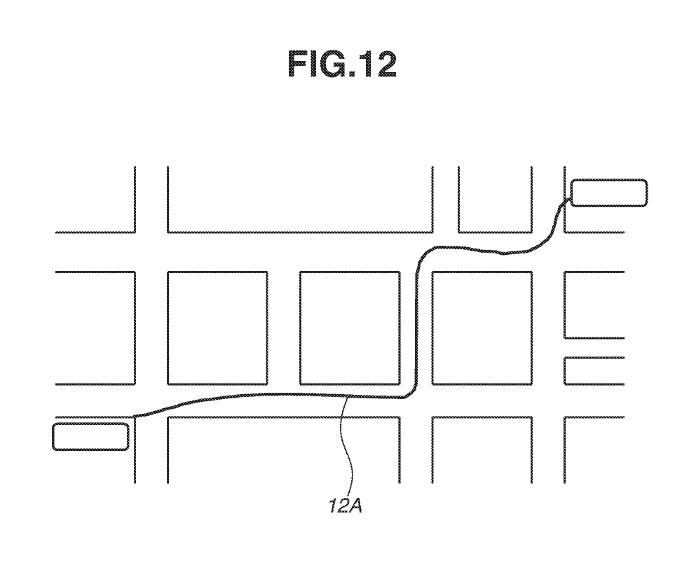

FIG. 12 illustrates a state in which the drawing of the predicted movement path line is completed.

In FIG. 12, a line 12A is the predicted movement path line drawn by the user.

In step S205, the control unit 12 determines whether the drawing of the predicted movement path line is completed. If the control unit 12 determines that the drawing of the predicted movement path line is completed (YES in step S205), the processing proceeds to step S206. If the control unit 12 determines that the drawing of the predicted movement path line is not completed (NO in step S205), the processing returns to step S204.

The processing performed in step S204 or in steps S204 and S205 is an example of reception processing of receiving input of information about a movement path of a tracking target subject.

In step S206, the control unit 12 executes predicted movement path analysis processing using the predicted movement path analysis unit 17b. Hereinbelow, in order to simplify the description, the control unit 12 instead of the predicted movement path analysis unit 17b executes predicted movement path analysis processing.

The first analysis processing is the processing of analyzing a user's intention based on a correspondence relationship between the predicted movement path line drawn by the user and the region map (FIG. 4).

For example, in a case of a wide road, the control unit 12 determines the line as a path passing by a building or sidewalk based on whether the line is drawn to designate a right or left edge. In a case of a curved line, the control unit 12 determines the line as a path for stopping by a store, an office, etc. located at the position of a vertex of the curve. The control unit 12 can acquire a user's intention by displaying an option button for specifying that the path can pass along either side of the road. In a case where a line is drawn a plurality of times, the control unit 12 can determine the line as an important path and increase a weighted value to be given to the camera location in the next processing.

As the second analysis processing, for example, the control unit 12 performs prediction analysis using a previous movement path of the tracking target on which previous tracking processing is executed. The previous movement path of the tracking target on which previous tracking processing is executed is recorded in the memory 102 via the storage unit 11 based on the management by the movement path management unit 21.

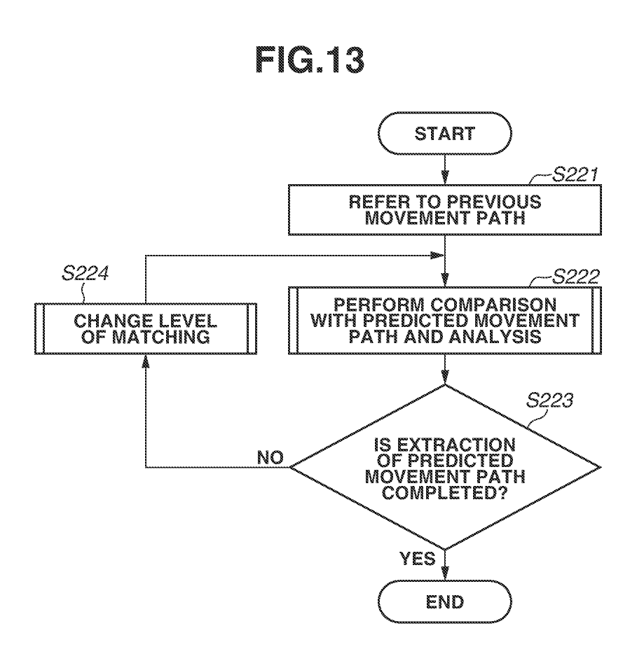

The information processing performed using a previous movement path will be described below with reference to FIG. 13.

In step S221, the control unit 12 refers to the previous movement path.

In step S222, the control unit 12 compares a movement path indicated by the referenced previous movement path with the predicted movement path drawn by the user, and analyzes the movement paths to perform matching. The control unit 12 extracts a predetermined number (e.g., two) of top predicted movement paths determined to have a matching level (level of matching) that is greater than or equal to a set value as a result of the matching processing.

In step S223, the control unit 12 determines whether the predicted movement path extraction is completed. If the control unit 12 determines that the predicted movement path extraction is completed (YES in step S223), the process illustrated in the flow chart in FIG. 13 is ended. If the control unit 12 determines that the predicted movement path extraction is not completed (NO in step S223), the processing proceeds to step S224.

In step S224, the control unit 12 changes the level of matching in step S222. For example, each time step S224 is performed, the control unit 12 decreases the level of matching by 10%.

Thereafter, the control unit 12 executes below-described tracking camera selection processing using the tracking camera selection management unit 18 based on a result of the predicted movement path analysis from the predicted movement path analysis unit 17b.

In step S207, the control unit 12 performs matching calculation based on the camera map (FIG. 5) stored in the storage unit 11 and selects a plurality of cameras 2 that capture video images of the predicted movement path lines.

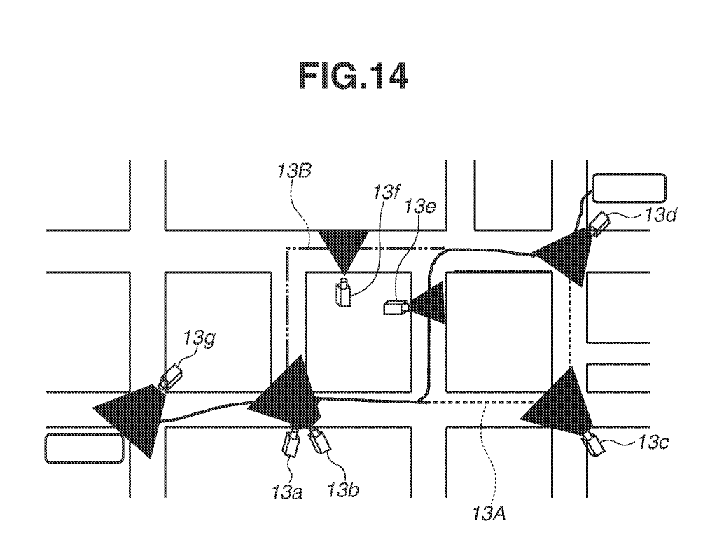

FIG. 14 illustrates a state in which the plurality of cameras 2 is selected.

In FIG. 14, paths 13A and 13B are the predicted movement paths that are additionally selected as a result of the predicted movement path analysis.

In FIG. 14, cameras 13a to 13g are the selected seven cameras 2.

Step S208 of tracking start processing is similar to step S108 in FIG. 3, so description of step S208 is omitted.

According to the foregoing configuration, the user does not perform an operation of selecting a tracking target on a setting screen on the management server 1. Instead, the user sets, as a line, a predicted path along which the tracking target is predicted to move. The management server 1 utilizes how the path line is drawn and the previous movement path to enable tracking processing on a plurality of paths.

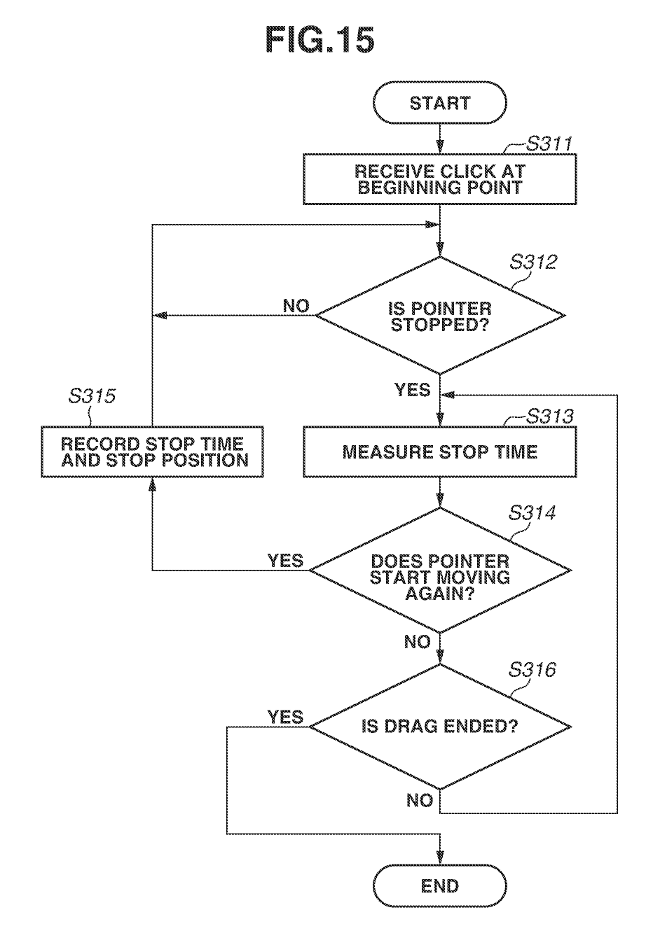

FIG. 15 is a flow chart illustrating details of the processing performed in step S213 in FIG. 11.

The user having selected the freehand input moves the mouse pointer, which is an example of the input device 105, to a beginning position of a predicted movement path for tracking and clicks on the beginning position. In step S311, the control unit 12 receives the click on the beginning point by the user via the input unit 16.

Thereafter, the user performs an operation called a drag without releasing the click of the mouse to draw a predicted movement path line by moving the mouse pointer on the region map (FIG. 4) displayed on the display unit 15.

There may be a case where the user performs an operation to stop the mouse pointer for a predetermined time at, for example, a corner such as an intersection, while dragging the mouse to draw a predicted movement path line.

In step S312, the control unit 12 determines whether the mouse pointer is stopped based on information received via the input unit 16. If the control unit 12 determines that the mouse pointer is stopped (YES in step S312), the processing proceeds to step S313. If the control unit 12 determines that the mouse pointer is not stopped (NO in step S312), step S312 is repeated.

In step S313, the control unit 12 measures the stop time of the mouse pointer. While the stop time of the mouse pointer is measured in the present exemplary embodiment, the measurement target is not limited to the stop time and can be information about an operation on the mouse pointer that indicates a dithering operation of the user.

In step S314, the control unit 12 determines whether the mouse pointer starts moving again, based on input via the input unit 16, etc. If the control unit 12 determines that the mouse pointer starts moving again (YES in step S314), the processing proceeds to step S315. If the control unit 12 determines that the mouse pointer does not start moving again (NO in step S314), the processing proceeds to step S316.

In step S315, the control unit 12 records the stop position and the stop time of the mouse pointer in the memory 102 via the storage unit 11. The mouse pointer is stopped and repeatedly moved, and a mouse button is released at the end point to end the drawing.

In step S316, the control unit 12 determines whether the drag is ended, based on input from the input unit 16. If the control unit 12 determines that the drag is ended (YES in step S316), the process illustrated in the flow chart in FIG. 15 ends. If the control unit 12 determines that the drag is not ended (NO in step S316), the processing returns to step S313.

Thereafter, the control unit 12 executes the following processing as the predicted movement path analysis processing.

The control unit 12 analyzes whether the stop position of the mouse pointer in the drawing of the predicted movement path line is an appropriate crossroads on the region map (FIG. 4).

The control unit 12 analyzes the stop time of the mouse pointer at the stop position determined as a crossroads and extracts a predetermined number (e.g., two) of movement paths on which the mouse pointer is stopped for the longest time. More specifically, the control unit 12 extracts a predetermined number (e.g., two) of movement paths on which the mouse pointer is stopped for the longest time at a crossroads from movement paths that are deleted or changed while the user draws the predicted movement path line from the beginning point to the end point. The predetermined number (e.g., two) of movement paths on which the mouse pointer is stopped for the longest time at a crossroads are an example of movement paths selected based on a drawing state from movement paths corrected or changed during the freehand input.

While the control unit 12 extracts two top movement paths from movement paths on which the mouse pointer is stopped for the longest time in the present exemplary embodiment, the number of movement paths to be extracted is not limited to two. Since it is difficult to see displayed movement paths, two movement paths from the top are described.

The control unit 12 selects a camera(s) 2 based on three movement paths including the two extracted movement paths and the predicted movement path drawn by the user. The subsequent processing from tracking camera selection processing to tracking processing is similar to that described above, so description of the subsequent processing is omitted.

As described above, the drawing of the user is measured and analyzed to extract a predicted movement path more suitable for a user's intention, select and set a camera(s) 2, and perform tracking processing.

The above-described exemplary embodiment is not seen to be limiting, and modifications as described below can be made.

For example, while the methods of designating a path by designating two points or by drawing a line are described above, any other methods can be used. For example, a path can be designated by designating a street name, latitude and longitude, or bridge to pass along (bridge to not pass along).

Other examples include a method of designating a path by designating a road (sidewalk, roadway, bicycle road, walking trail, underpass, roofed road, road along which a person can walk without an umbrella), designating a path on a second floor above the ground, designating a path without a difference in level, designating a path with a handrail, or designating a path along which a wheelchair is movable.

While the mouse is used to draw a predicted path on the region map, the input device is not limited to the mouse. For example, the region map can be displayed on a touch panel display where a finger or pen can be used to draw a predicted path.

A barcode can be attached in a real space to designate a predicted path.

While a predicted path is drawn just along a road outside a building on the region map, the drawing of a predicted path is not limited to the above-described drawing. For example, a predicted path that passes through a building, store, or park can be drawn. In this case, the layout of a building or park can be displayed, and a detailed predicted path can be drawn to indicate how a predicted path moves inside the building or park.

While the control unit 12 performs matching calculation and selects the cameras 2 that capture predicted movement path lines as video images based on the camera map (FIG. 5) stored in the memory 102 via the storage unit 11, the control unit 12 can change image-capturing parameters of the cameras 2 during the selection of the plurality of cameras 2 so that images of predicted movement path lines can be captured from predicted video images with the changed image-capturing parameters.

A feature amount of a head portion can be used as information for identifying a tracking target subject. In addition to a feature amount of a head portion, a feature amount of a face, skeleton, clothes, or gait of a person can be used.

The region map to be displayed can be a three-dimensional (3D) map.

The functions of the management server 1 can be implemented by, for example, a plurality of cloud computers.

While the control unit 12 selects the plurality of cameras 2 and executes tracking processing using video images captured by the plurality of selected cameras 2, the processing is not limited to this example. The control unit 12 of the management server 1 can generate a plurality of combined video images by combining video images captured by the plurality of cameras 2 and then select and designate the plurality of generated video images for use.

In the information processing according to the above-described exemplary embodiments, the setting of tracking can be performed before a tracking target subject appears on a monitoring camera without performing an operation of determining a tracking target by observing a management screen at the start of the setting of tracking. This provides a subject tracking setting method that enables easy camera selection at the time of tracking.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-193702, filed Sep. 30, 2016, which is hereby incorporated by reference herein in its entirety.

What is claimed is:

1. An information processing apparatus comprising:
a reception unit configured to receive input of information about a path;
a selection unit configured to select an image capturing device corresponding to the path from a plurality of image capturing devices based on the received information about the path; and
a processing unit configured to track a subject contained in a video image captured by the selected image capturing device.

2. The information processing apparatus according to claim 1, further comprising:
a generation unit configured to generate a region map about a monitoring target region; and
a display unit configured to display the generated region map,
wherein the reception unit receives input of information about a path of the subject to be tracked on the displayed region map.

3. The information processing apparatus according to claim 1, further comprising:
a first generation unit configured to generate a region map about a monitoring target region;
a second generation unit configured to generate a camera map with camera location information superimposed on the generated region map; and
a display unit configured to display the generated camera map,
wherein the reception unit receives input of information about a path of the subject to be tracked on the displayed camera map.

4. The information processing apparatus according to claim 1,
wherein the reception unit receives input of two points that are a start point and an end point of the path as the information about the path of the subject, and
wherein the selection unit selects at least one image capturing device corresponding to a plurality of paths between the two points as the path of the subject based on the received input two points.

5. The information processing apparatus according to claim 1,
wherein the reception unit receives input of an instruction point of the path as the information about the path of the subject, and
wherein the selection unit selects an image capturing device corresponding to the path of the subject to be tracked based on the received input of an instruction point of a plurality of paths.

6. The information processing apparatus according to claim 1, wherein the selection unit selects at least one image capturing device corresponding to a plurality of paths of the subject to be tracked based on a comparison between a predicted path based on the input instruction point and a previous path.

7. The information processing apparatus according to claim 1,
wherein the reception unit receives freehand input of the path as the information about the path of the subject, and
wherein the selection unit selects an image capturing device corresponding to the path of the subject based on the received freehand input of the path.

8. The information processing apparatus according to claim 7, wherein the selection unit selects at least one image capturing device corresponding to a plurality of paths of the subject based on a comparison between a predicted path based on the freehand input and a previous path.

9. The information processing apparatus according to claim 7, wherein the selection unit selects at least one image capturing device corresponding to a plurality of paths of the subject based on a comparison between a predicted path based on the freehand input and a path selected based on a drawing state from paths corrected or changed during the freehand input.

10. An information processing method comprising:
receiving input of information about a path;
selecting an image capturing device corresponding to the path from a plurality of image capturing devices based on the received information; and
tracking a subject contained in a video image captured by the selected image capturing device.

11. The information processing method according to claim 10, further comprising:
generating a region map about a monitoring target region; and
displaying the generated region map,
wherein the receiving receives input of information about a path of the subject to be tracked on the displayed region map.

12. The information processing method according to claim 10, further comprising:
generating a region map about a monitoring target region;
generating a camera map with camera location information superimposed on the generated region map; and
displaying the generated camera map,
wherein the receiving receives input of information about a path of the subject to be tracked on the displayed camera map.

13. The information processing method according to claim 10,
wherein the receiving receives input of two points that are a start point and an end point of the path as the information about the path of the subject, and
wherein the selecting selects at least one image capturing device corresponding to a plurality of paths between the two points as the path of the subject based on the received input two points.

14. The information processing method according to claim 10,
wherein the receiving receives input of an instruction point of the path as the information about the path of the subject, and
wherein the selecting selects an image capturing device corresponding to the path of the subject to be tracked based on the received input of an instruction point of a plurality of paths.

15. The information processing method according to claim 10, wherein the selecting selects at least one image capturing device corresponding to a plurality of paths of the subject to be tracked based on a comparison between a predicted path based on the input instruction point and a previous path.

16. The information processing method according to claim 10,
wherein the receiving receives freehand input of the path as the information about the path of the subject, and
wherein the selecting selects an image capturing device corresponding to the path of the subject based on the received freehand input of the path.

17. The information processing method according to claim 16, wherein the selecting selects at least one image capturing device corresponding to a plurality of paths of the subject based on a comparison between a predicted path based on the freehand input and a previous path.

18. The information processing method according to claim 16, wherein the selecting selects at least one image capturing device corresponding to a plurality of paths of the subject based on a comparison between a predicted path based on the freehand input and a path selected based on a drawing state from paths corrected or changed during the freehand input.

19. A non-transitory storage medium storing a program for causing a computer to execute a method, the method comprising:
receiving input of information about a path;
selecting an image capturing device corresponding to the path from a plurality of image capturing devices based on the received information; and
tracking a subject contained in a video image captured by the selected image capturing device.
